(19) United States
(12) Patent Application Publication
(10) Pub. No.: US 2020/0029086 A1
(43) Pub. Date: Jan. 23, 2020

(54) DISTRIBUTED AND PARALLEL VIDEO STREAM ENCODING AND TRANSCODING

(71) Applicant: Intel Corporation, Santa Clara, CA (US)

(72) Inventors: Yi Zou, Portland, OR (US); Gang Shen, Hillsboro, OR (US); Jun Tian, Portland, OR (US)

(73) Assignee: Intel Corporation, Santa Clara, CA (US)

(21) Appl. No.: 16/584,873

(22) Filed: Sep. 26, 2019

(51) Int. Cl. H04N 19/436; H04N 19/172; H04N 19/40

(52) U.S. Cl. CPC H04N 19/436; H04N 19/40; H04N 19/172

(57) ABSTRACT

In one embodiment, an apparatus comprises processing circuitry to: receive, via a communication interface, a frame of a video stream; determine a number of subframes to be encoded in parallel for the frame; partition the frame into a plurality of subframes based on the number of subframes to be encoded in parallel; and send, via the communication interface, the plurality of subframes to a cluster of encoding servers, wherein the cluster of encoding servers is to encode the plurality of subframes in parallel, and wherein each subframe of the plurality of subframes is to be encoded by a particular encoding server of the cluster of encoding servers.

### FIELD OF THE SPECIFICATION

This disclosure relates in general to the field of video streaming, and more particularly, though not exclusively, to distributed and parallel video stream encoding and transcoding.

### BACKGROUND

As online video streaming continues to rise in popularity, modern video streaming applications are constantly demanding higher video resolutions and lower end-to-end streaming latency, particularly for ultra-high-definition (UHD), live, and/or real-time video content. As a result, video encoding and transcoding has become a bottleneck in the pipeline of video streaming applications, and current video streaming systems cannot be easily scaled to improve the video encoding and transcoding efficiency.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 illustrates an example embodiment of a distributed and parallel video encoding system.

FIG. 2 illustrates an example of a centralized video streaming system.

FIGS. 3A-C illustrate various examples of video encoding and transcoding in centralized video streaming systems.

FIG. 4 illustrates an example of distributed and parallel video stream encoding using frame chunking.

FIG. 5 illustrates an example of a centralized video transcoding system that leverages frame chunking.

FIGS. 6-7 illustrate examples of distributed and parallel video transcoding systems that leverage frame chunking.

FIG. 8 illustrates a flowchart for an example embodiment of distributed and parallel video stream encoding and transcoding.

FIGS. 9, 10, 11, and 12 illustrate examples of Internet-of-Things (IoT) networks and architectures that can be used in accordance with certain embodiments.

FIGS. 13 and 14 illustrate example computer architectures that can be used in accordance with certain embodiments.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

As video continues to dominate the overall volume of traffic over the Internet, cloud-based video encoding and transcoding has become critical to the quality of service of video streaming applications. In particular, ultra-high-definition (UHD), live streaming, and real-time video (e.g., cloud-based video game, virtual reality (VR), and/or augmented reality (AR) streaming) typically requires the lowest end-to-end latency compared to other types of streaming video content.

For example, a 360 degree video with 8K resolution and a frame rate of 60 frames per second (FPS) demands an inter-frame latency as low as 18 milliseconds (ms) per frame (e.g., 1000 ms/60 frames). The end-to-end latency to stream a video frame primarily involves encoding latency, transmission latency, and decoding latency. The latency generated by the video codec (e.g., encoding and decoding) contributes to most of the end-to-end latency, and that trend is only expected to continue as ultra-high-definition (UHD) video (e.g., 8K and above) becomes more mainstream and the bandwidth and/or capacity of communication channels (e.g., 5G cellular networks) becomes larger.

Current video streaming solutions focus primarily on improving video codecs and scaling up the resources used for video encoding (e.g., vertical scaling), such as using new video codec standards, more sophisticated encoding algorithms, and/or more powerful compute hardware to perform video encoding (e.g., CPUs, GPUs, hardware video encoders), among other examples. However, this approach imposes a financial burden on video service providers and application developers, and it fails to utilize the elasticity of cloud computing that is available nowadays.

For example, the latest video encoding algorithms and standards are designed to achieve a better compression ratio with minimum quality loss, such as the Advanced Video Coding (AVC) or H.264 standard, the High Efficiency Video Coding (HEVC) or H.265 standard, and the VP9 standard, among other examples. When it comes to low-latency real-time video streaming, however, the computational complexity of these codecs actually increases the encoding and decoding latency for frames in a video stream, which consequentially increases the end-to-end latency for streaming those frames.

This problem is further compounded by the continuous demand for higher video resolution, as increasing the resolution of a video stream similarly increases the encoding and decoding latency, and by extension, the end-to-end streaming latency. This can be particularly problematic for virtual reality (VR) and/or 360 degree video content, as that type of content often demands ultra-high video resolutions (e.g., 8K, 16K, 24K, or even higher), which can significantly increase the encoding, decoding, and end-to-end streaming latency.

In some cases, codec standards may leverage “tiles” to achieve better parallelism during encoding and decoding. However, due to spatial and temporal dependencies associated with video stream coding, parallelism based on tiles is limited to one encoder/decoder instance on one costly multiprocessor machine and largely limited to specific codec standards. As a result, video service providers have to constantly purchase new hardware (e.g., CPUs, GPUs) and continuously upgrade to new or specific video codecs to keep up with the computational demands of video coding.

Accordingly, this disclosure presents various embodiments of a distributed video encoding system that leverages frame chunking and parallel encoding to encode and transcode video streams more efficiently.

In particular, current video codecs encode full video frames as input, which precludes the possibility of encoding the content of a single frame across multiple machines in parallel (e.g., which is particularly problematic for a frame with UHD video content). The described solution, however, decouples video stream chunking (or slicing) from the actual encoding and transcoding, which effectively allows the current encoding pipeline to be transformed into a distributed workflow for maximal parallelism. For example, each frame of an incoming video stream received over time is chunked or sliced into subframe regions before feeding the subframes into a cluster of encoding servers to be encoded in parallel. In this manner, the inherent data parallelism in video frame data based on subframe regions can be leveraged to scale out concurrent video encoding and/or transcoding workloads to any number of encoding servers on demand.

Further, an index file format with metadata specifying the spatial regions of subframes can be used to assemble and stitch the subframes back into the original frame for consumption or playback of a video stream. Moreover, in some cases, the original frame may only need to be partially decoded and reconstructed, and thus the metadata can be used to selectively decode and reassemble only the subframes that are actually needed instead of unnecessarily decoding the entire frame. For example, as video resolution increases, the full content within each video frame is not always needed for consumption or playback of a video stream, particularly for AR/VR content and/or 360 degree video content, which typically only requires the portion of each frame within the field of view of a user to be consumed or displayed.

Accordingly, the described solution introduces a framework of distributed video stream data encoding and transcoding for video cloud and video fog applications, which may include any of the following novel aspects and advantages (among other examples):
(i) a scale-out distributed architecture (e.g., horizontally scalable) for video encoding and transcoding;
(ii) optimal use of parallelism in video encoding and transcoding;
(iii) reduced encoding and transcoding latency for video streaming; and
(iv) significant flexibility to leverage existing computing architectures and platforms (e.g., Intel x86 architectures) to perform video encoding and transcoding in a manner that satisfies the continuously increasing compute and quality of service demands of modern video streaming applications and use cases.

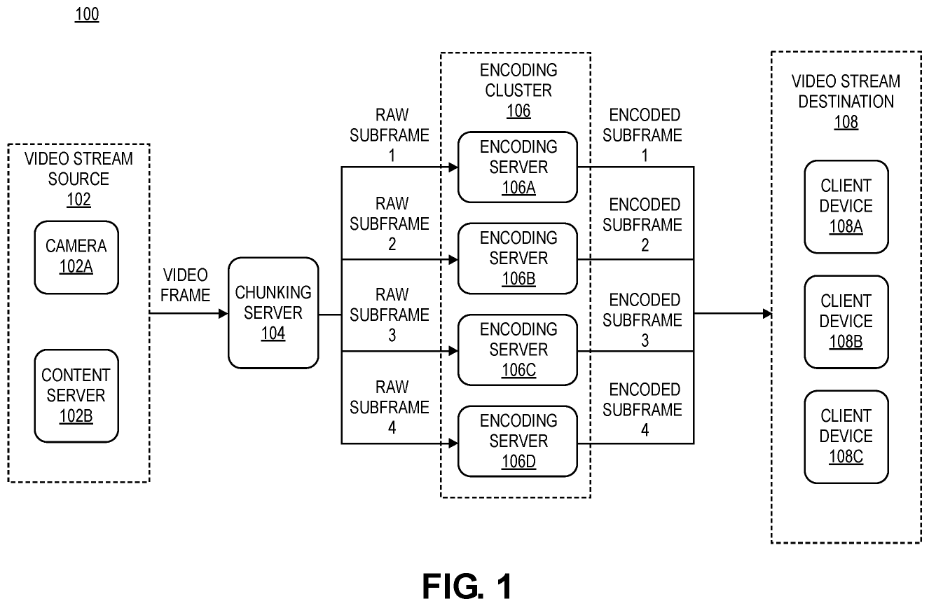

FIG. 1 illustrates an example embodiment of a distributed and parallel video encoding system 100 that leverages frame chunking and parallel encoding. In the illustrated embodiment, distributed video encoding system 100 includes a video stream source 102, a chunking server 104, an encoding cluster 106, and a video stream destination 108. The video stream source 102 initially streams the frames of a video stream to the chunking server 104, which partitions each frame into a particular number of raw subframes corresponding to different spatial regions, and the raw subframes for each frame are then sent to a cluster of encoding servers 106a-d to be encoded in parallel. The encoded subframes for each frame are then streamed to the video stream destination 108. In this manner, each individual frame of the video stream is encoded in parallel across the cluster of encoding servers 106a-d in a distributed and scalable manner, which significantly reduces the per-frame encoding latency, as described further below.

The video stream source 102 can include any component, device, and/or platform that provides the underlying video content for a particular video stream, such as a camera 102a and/or a video content server 102b. For example, a camera 102a may be used to capture and stream live video content, and/or a video content server 102b may be used to stream stored video content (e.g., on-demand movies and television shows), live video content (e.g., sporting events, news), and/or real-time video content (e.g., cloud video game content, AR/VR content).

The video stream destination 108 can include any component, device, and/or platform that receives an encoded video stream, such as a client or end-user device 108a that performs playback of the video content within the encoded video stream, a video content server 108b that stores the encoded video stream for subsequent streaming to client devices 108a, and/or a video analytics server 108c that performs analytics on the encoded video stream.

The chunking server 104 and the encoding servers 106a-d can include any computing components, devices, and/or platforms that collectively perform encoding and/or transcoding of a video stream transmitted from the video stream source 102 to the video stream destination 108, as described further below. In some embodiments, for example, each server may be a physical machine, virtual machine, and/or any other processing device, platform, or node (e.g., a server in a datacenter in the edge or cloud).

Moreover, the respective components of distributed video encoding system 100 (e.g., video stream source 102, video stream destination 108, chunking server 104, and encoding servers 106a-d) may be distributed anywhere throughout an edge-to-cloud network topology, including at the edge, in the cloud, and/or anywhere in between in the “fog.”

The video stream source 102 initially streams a video stream to the chunking server 104 as a sequence of raw or encoded video frames. Upon receiving each frame, if the frame is encoded, the chunking server 104 first decodes the frame into a raw frame. For example, even when a frame is already encoded upon receipt, it often needs to be encoded and/or streamed to the particular video stream destination 108 in a different format than that in which it is originally received (e.g., using another video codec, streaming protocol, and/or encoding or streaming parameters). Thus, an encoded frame is first decoded into a raw frame so it can be encoded and/or streamed to the destination 108 in the appropriate format.

The chunking server 104 then partitions the raw frame into a particular number of raw subframes corresponding to different spatial regions of the frame, and the raw subframes are then sent to a cluster of encoding servers 106a-d to be encoded in parallel.

In some embodiments, for example, the chunking server 104 may send each subframe to a specific encoding server 106a-d to handle the encoding, or the chunking server 106 may broadcast or multicast all subframes to the entire cluster of encoding servers 106, and each encoding server 106 may handle the encoding of one or more of the subframes. For example, each subframe may be tagged with metadata indicating its corresponding spatial region within the frame. In addition, the encoding servers 106a-d may be “region aware,” meaning they each handle the encoding of a subframe that corresponds to a particular spatial region of the frame. In this manner, the metadata enables each encoding server 106a-d to encode the particular subframe corresponding to its assigned spatial region of the frame (e.g., using the appropriate video codec and/or encoding parameters). The metadata also enables the full frame to be subsequently reconstructed when the encoded subframes are decoded for playback at the video stream destination 108, as described further below.

In this manner, each of the raw subframes for a particular frame may be independently encoded in parallel by a particular encoding server in the encoding cluster 106a-d (e.g., using a particular video codec and/or encoding parameters), thus producing encoded subframes that correspond to the respective raw subframes. The encoded subframes generated by the encoding cluster 106a-d are then streamed to the video stream destination 108, where they may be decoded for video playback (e.g., by a client or end-user device 108a or another processing device) and/or stored for subsequent streaming (e.g., by a content server 108b). With respect to video playback, for example, the encoded subframes may be decoded into raw subframes, and the raw subframes may then be reassembled into the original frame based on the metadata indicating their corresponding spatial regions within the original frame.

In some embodiments, the number of subframes used to encode each frame can be dynamically tuned based on the level of encoding parallelism required for a particular video streaming application and/or use case. For example, each subframe of an individual frame may be encoded in parallel by a separate encoding server in the encoding cluster 106. As a result, increasing the number of subframes that are separately encoded for a particular frame increases the number of encoding servers 106a-d that are leveraged in parallel to encode that frame, which increases the per-frame encoding parallelism and decreases the per-frame encoding latency.

The number of subframes used for encoding can be determined based on various criteria, such as the type of video content streamed by a particular application or use case, the compute requirements for encoding that type of video content, quality of service (QoS) requirements and/or service level agreements (SLAB) for encoding and/or streaming the video content, and so forth. For example, ultra-high-definition (UHD) video streamed in real time requires significant computing overhead to encode, yet it must be encoded with very low latency to provide good quality of service. Thus, for that type of video content, a larger number of subframes may be used to encode each frame in order to increase the per-frame encoding parallelism and reduce the per-frame encoding latency.

In this manner, encoding system 100 is highly scalable, as it can be horizontally scaled by simply increasing the number of subframes and corresponding encoding servers 106 that are used to encode each frame of a video stream.

Moreover, because each subframe of a single frame is independently encoded by a particular encoding server 106, encoding system 100 also provides the flexibility to use different video codecs and/or encoding parameters on different regions or subframes of a single frame. As an example, for AR/VR or 360 degree video content, the regions of a frame that are within a user's current field of view (FOV) may be encoded differently than those that are outside the FOV. For example, subframes within the FOV may be encoded using video codecs and/or encoding parameters that provide higher resolution, better video quality, and/or lower data loss than those used for subframes outside the FOV. In this manner, encoding system 100 can tailor the video codecs and/or encoding parameters applied to different regions or subframes of a single frame to optimize the encoding latency, video quality, and/or bandwidth consumption for a particular video streaming application.

Encoding system 100 may also leverage various types of hardware acceleration to further optimize video encoding performance. In some embodiments, for example, the chunking server 104 may leverage hardware acceleration to accelerate the frame chunking and transmission functionality (e.g., using smart network interface controllers (NICs), field-programmable gate arrays (FPGAs), and/or application-specific integrated circuit (ASICs)). Similarly, the encoding servers 106a-d may leverage hardware acceleration to accelerate the video encoding functionality (e.g., using hardware video processors or co-processors, graphics processing units (GPUs), FPGAs, and/or ASICs). Moreover, in some embodiments, the chunking server 104 may also function as an encoding server 106a-d, and thus the chunking server 104 may similarly leverage hardware acceleration to accelerate its video encoding functionality. Further, in some embodiments, each encoding server 106a-d (and potentially the chunking server 104) may include multiple hardware video encoders to further improve the video encoding parallelism (e.g., whether for a single video stream or multiple video streams).

Video content capturing, processing, and delivery currently faces many challenges. However, the described solution enables existing computing architectures and platforms (e.g., Intel x86 architectures) to be leveraged for video analytics and video content delivery at the edge and through the cloud while satisfying the continuously increasing compute and quality of service demands of modern video streaming applications and use cases. In particular, the described solution provides numerous advantages, including a distributed and parallel approach for scaling out video encoding workloads, reduced encoding latency for real-time video applications, and reduced total cost of ownership (TCO) for video encoding and transcoding services in datacenters.

For example, the described solution enables a scale-out architecture for cloud service providers (CSPs) and content delivery network (CDN) providers, which allows existing computing architectures (e.g., Intel x86 architectures) to be applied in a linear scale-out manner for video stream encoding and transcoding.

The described solution also reduces video encoding latency, even without any modifications to existing video codec technologies (e.g., existing video coding software and/or hardware modules).

Further, the described solution reduces the total cost of ownership (TCO) for video streaming, encoding, and/or transcoding services provided by CSPs and CDNs. For example, allowing the encoding to be performed in a distributed manner across a configurable number of encoding servers greatly improves the video encoding efficiency for CSPs and CDNs. In particular, the single server bottleneck for video encoding and transcoding is eliminated, and the compute resources for video encoding and decoding can be dynamically and independently scaled, which reduces the TCO for CSPs and CDN providers.

Additional functionality and embodiments are described further in connection with the remaining FIGURES. Accordingly, it should be appreciated that distributed video encoding system 100 of FIG. 1 may be implemented with any aspects of the embodiments described throughout this disclosure.

Centralized Video Stream Encoding

With the advancement of various hardware and software technologies, cameras capable of capturing high quality video (e.g., SD, HD, or even UHD video content) have become increasingly available for large volume deployment. Meanwhile, innovations in resource-constrained devices (e.g., devices with compact and low-power form factors), machine learning, and AI technologies-particularly in mobile smart phones and Internet of Things devices-have created many new challenges relating to video content delivery and processing. In particular, the sheer volume of data from video captured by cameras running 24/7, coupled with the vast scale and variety of client devices, presents many challenges from a computing, networking, and storage perspective.

For example, in the context of video-based applications that leverage edge, fog, and/or cloud computing, numerous cameras are typically deployed in designated locations to capture live events that occur in the respective camera views, such as at street intersections for traffic monitoring, or on-premises of a facility (e.g., a home, business, or campus) for security, surveillance, and intrusion detection, among other examples. The videos captured by the cameras are then delivered to certain endpoints, such as: (i) client devices for real-time video playback; (ii) storage systems to be persistently stored for subsequent replay on client devices; and/or (iii) servers for video analytics.

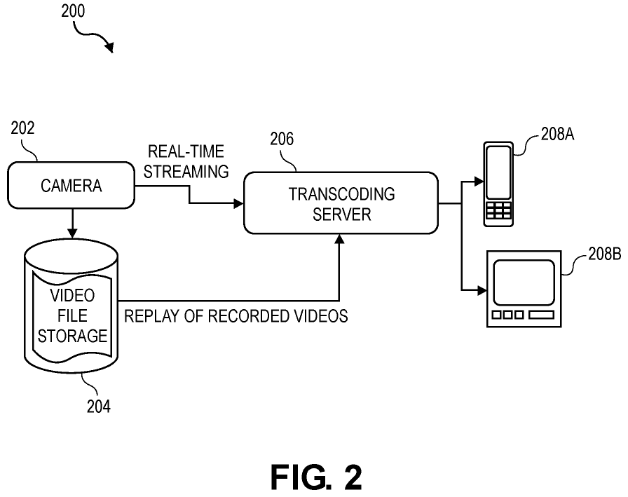

FIG. 2 illustrates an example 200 of how video is currently delivered to client devices. In the illustrated example, video captured by a camera 202 can be streamed to a particular client device 208a,b (e.g., smart phone, personal computer, closed-circuit television (CCTV)) in real time, or the video can be stored persistently on a storage system 204 and streamed to the client device 208a,b for replay at a later time. The storage system 204 can be deployed locally at the edge (e.g., near the camera 202), remotely in the cloud, or anywhere in between in the fog. Similarly, the client devices 208a,b can be local to the camera 202, such as on the same local area network (LAN) and/or within a few network hops (e.g., in a nearby security monitoring and surveillance room), or the client devices 208a,b can be remote from the camera 202, such as over a wide area network (WAN) (e.g., for remote surveillance). Prior to streaming the video to a particular client device 208a,b, however, a transcoding server 206 is used to encode (or transcode) the video into a digitally encoded format supported by that client device (e.g., H.264 Advanced Video Coding format). In this manner, the transcoding server 206 enables the video to be streamed to different client devices using different media coding formats.

With the landscape of the broadcasting business being reshaped by online video streaming services (e.g., Netflix, Google/YouTube, iQiyi), Internet Protocol (IP) networking has successfully established itself as the de facto standard for scale-out video content delivery. Multiple open and proprietary standards exist for video streaming data delivery over IP networks, such as the Real Time Streaming Protocol (RTSP), the Real Time Messaging Protocol (RTMP), HTTP Live Streaming (HLS), Dynamic Adaptive Streaming over HTTP (MPEG-DASH), and so forth. Meanwhile, standards committees (e.g., International Organization for Standardization (ISO), International Electrotechnical Commission (IEC)) are constantly refreshing video encoding standards (e.g., MPEG standards such as H.264/AVC and H.265/HEVC) with features tailored towards video streaming applications involving high-resolution video (e.g., HD or UHD), 360 degree views, AR/VR content, and so forth.

With these advancements in video streaming technology, however, video encoding and transcoding has become a bottleneck in the video streaming pipeline. As a result, the ability to truly scale out video encoding to improve its efficiency has become one of the biggest challenges of modern video streaming.

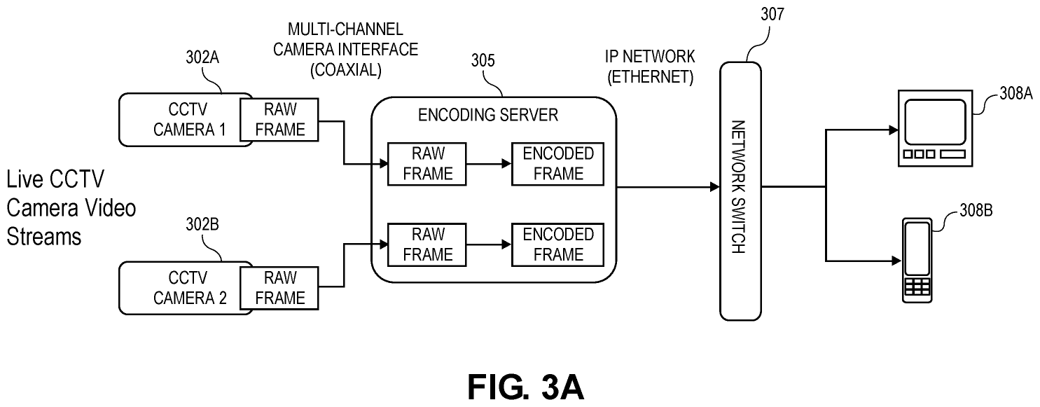

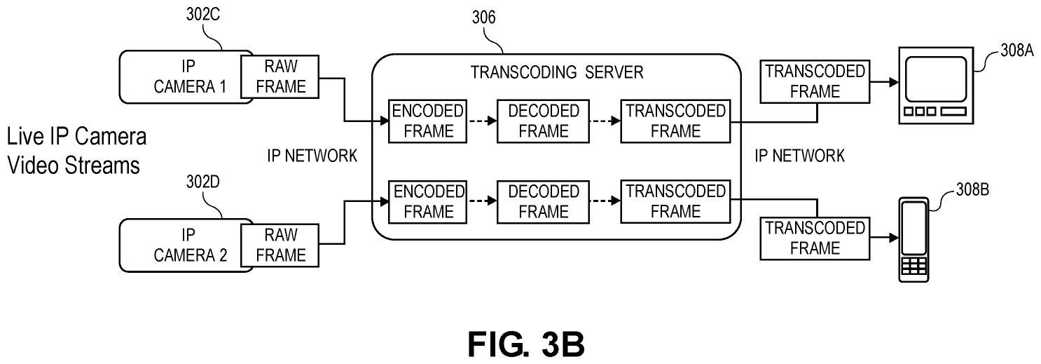

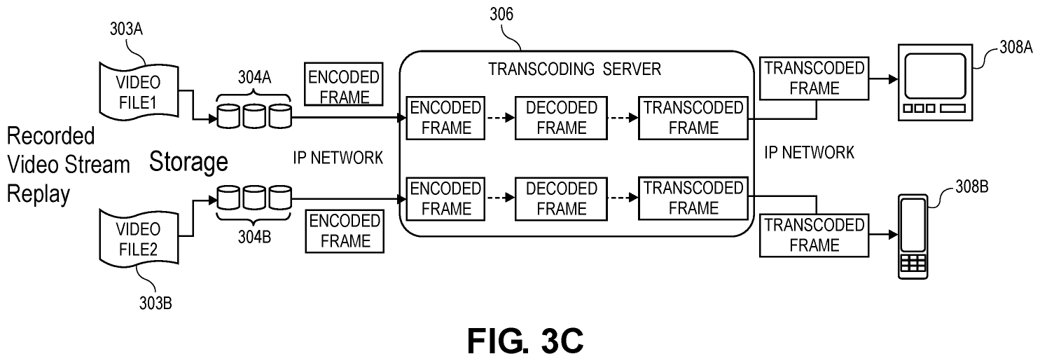

FIGS. 3A-C illustrate various examples of video encoding and transcoding in centralized video streaming systems. For example, in FIG. 3A, multiple closed-circuit television (CCTV) cameras 302a,b capture live video scenes that are sent as analog video signals (e.g., via coaxial cable) to a video encoding server 305 with a multi-channel camera interface, which is commonly seen in surveillance deployments. The encoding server 305 converts the raw analog video signals into digital video signals, encodes each digital video using a designated video codec (e.g., MPEG-4 AVC/H.264), and then streams the encoded videos to client devices 308a,b over an IP network via a network switch 307 (e.g., using RTSP, HLS). The client devices 308a,b then receive, decode, and play the videos.

In FIG. 3B, Internet Protocol (IP) cameras 302c,d capture and encode live video scenes using a default video codec and resolution, and the encoded videos are then streamed over an IP network (e.g., using RTSP, HLS) to a transcoding server 306. The transcoding server 306 decodes and then re-encodes the videos using specific video codecs based on the requirements of the corresponding endpoint or client devices 308a,b, and the encoded videos are then streamed to the client devices 308a,b over an IP network. The client devices 308a,b then receive, decode, and play the videos.

In FIG. 3C, video files 303a,b (e.g., recorded videos) are streamed from storage systems 304a,b to different endpoint or client devices 308a,b over an IP network. For example, the video files 303a,b are encoded using a default video codec and resolution and persisted on storage systems 304a,b ahead of time. When the client devices 308a,b are subsequently ready to replay the videos, the encoded video files 303a,b are streamed from the storage systems 304a,b to a transcoding server 306 over an IP network (e.g., using RTSP, HLS). The transcoding server 306 decodes and then re-encodes the videos using specific video codecs based on the requirements of the corresponding client devices 308a,b, and the encoded videos are then streamed to the client devices 308a,b over an IP network. The client devices 308a,b then receive, decode, and play the videos.

As demonstrated by FIGS. 3A-C, an encoding or transcoding server 305, 306 generally requires substantial compute and memory capabilities in order to perform real-time encoding or transcoding with as little latency overhead as possible. The end to end latency requirement can be as low as sub-100 ms in some cases (e.g., online gaming) and tens of seconds in others (e.g., on-demand video streaming). In any event, it is clear from FIGS. 3A-C that the centralized encoding or transcoding server 305, 306 is the bottleneck for purposes of linearly scaling the compute resources for encoding and transcoding. Fundamentally, adding more encoding/transcoding servers, or adding a more powerful CPU or more memory to an existing encoding/transcoding server, is ineffective for purposes of scaling due to the lack of a distributed video encoding/transcoding architecture that can take full advantage of spatial encoding and transcoding parallelism. This fundamental architecture limitation of the centralized solutions in FIGS. 3A-C makes it very difficult to scale video stream encoding and transcoding with the continuously growing volume of video data and the increasing number of cameras and other vision sensors that are being deployed.

For example, in FIGS. 3A-C, a video stream is fed into a centralized encoding or transcoding server, which performs encoding/transcoding on the input video stream on a frame-by-frame basis. Each frame is encoded to represent the entire region in the original field of view (FOV) of a camera or a source video file at a particular moment in time. As a result, the encoding process operates on full frames as input.

There are various forms of segmentation that could potentially be leveraged to improve the parallelism of the video encoding process:
(i) temporal: a video stream can be split into groups of pictures (GOPs) for different time intervals of a video (e.g., such that each GOP includes a group of sequential video frames or slices for a particular time interval), and each GOP can be independently encoded/decoded;
(ii) spatial: each frame of the video stream can be divided into multiple tiles that are separately encoded.

These segmentation methods cannot achieve true parallelism in centralized video encoding solutions, however, particularly with respect to modern video streaming services with 360 degree video content and/or real-time streaming demands.

For example, for 360 degree video content (e.g., AR/VR content streamed to a head mounted display (HMD) or headset), a user does not typically see the entire 360 degree view all at once-rather, the user only sees a portion of each 360 degree video frame based on the user's current field of view (FOV) at the time. As a result, the portion of each 360 degree video frame in the user's current FOV is much more important to the user experience than the remaining portions of each frame in other viewports of the 360 degree video.

In centralized video encoding solutions, however, each full-view frame is encoded in its entirety by a single encoder. As a result, the processing to encode a single frame is limited to a single machine, as it is difficult to apply load balancing and leverage computing power from other machines to collectively encode the same frame in parallel.

Moreover, as video resolutions continuously become larger, more processing time is required to encode each frame (e.g., assuming the encoding quality and/or parameters otherwise remain the same). As a result, video encoding software and hardware must be constantly upgraded in order to meet the increasingly stringent latency requirements for video streaming, which becomes a financial burden to video service providers.

Distributed and Parallel Video Stream Encoding

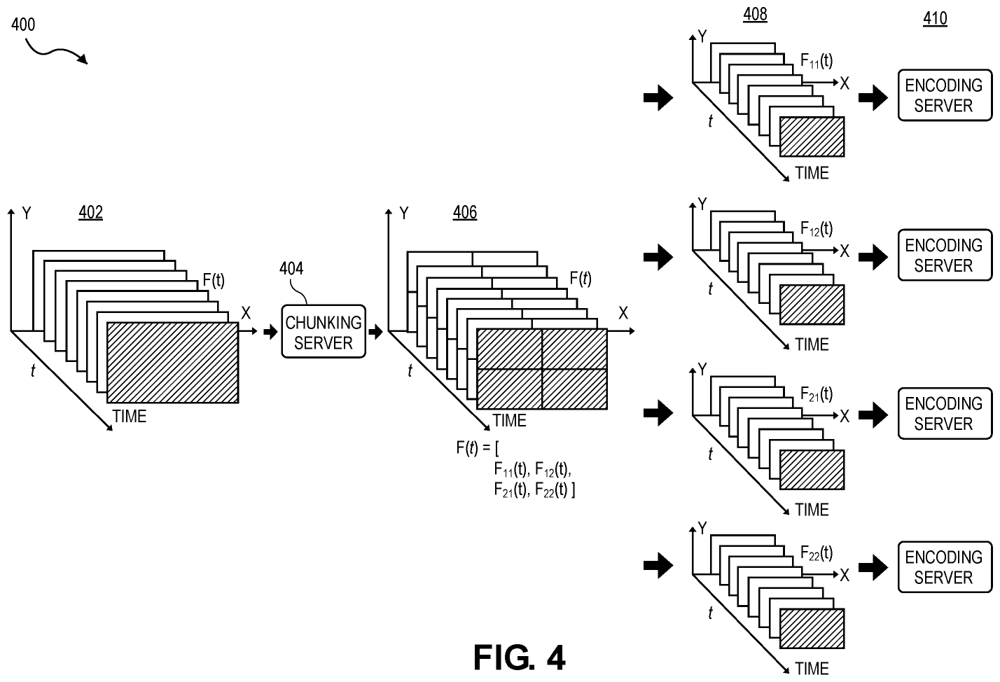

FIG. 4 illustrates an example 400 of distributed and parallel video stream encoding using frame chunking. For example, as described further below, each frame of a video stream 402 is partitioned into a particular number of non-overlapping spatial regions, referred to as “chunks” or subframes, which are independently encoded in parallel. In this manner, a full frame is encoded with significantly higher parallelism, as many smaller chunks or subframes of the full frame are encoded concurrently.

In the illustrated example, the video stream 402 includes a sequence of video frames ordered in time. The frames of the video stream 402 are fed sequentially into a chunking server 404, which partitions each frame into a particular number of “chunks” or subframes that correspond to different non-overlapping spatial regions within each frame 406.

The respective subframes or chunks of each frame 408 are then concurrently sent to an encoding cluster 410 to perform parallel encoding or transcoding. In some embodiments, for example, each subframe or chunk of a single frame is independently encoded in parallel by a different encoding server in the encoding cluster.

In the illustrated example, each frame is partitioned into four subframes that are encoded in parallel. The number of subframes used to encode each frame, however, may vary based on the level of encoding parallelism required for a particular video streaming application, as described further throughout this disclosure. For example, for a frame divided into k regions or subframes (e.g., k=4 in the above example), k levels of parallelism are effectively achieved for video encoding and transcoding.

Moreover, the relative geometry and/or location of the subframes within their corresponding parent frame may be included as metadata during encoding to enable the subframes to be reassembled into a full frame when they are decoded. For example, for a frame with a resolution of 640×480 and a number of chunks equal to four (k=4), the frame is partitioned into four subframes with a resolution of 320×240, which can be identified in the following manner using metadata:

### F₁₁=[1-320, 241-480]

### F₁₂=[321-640, 241-480]

### F₂₁=[1-320, 1-240]

### F₂₂=[321-640, 1-240]

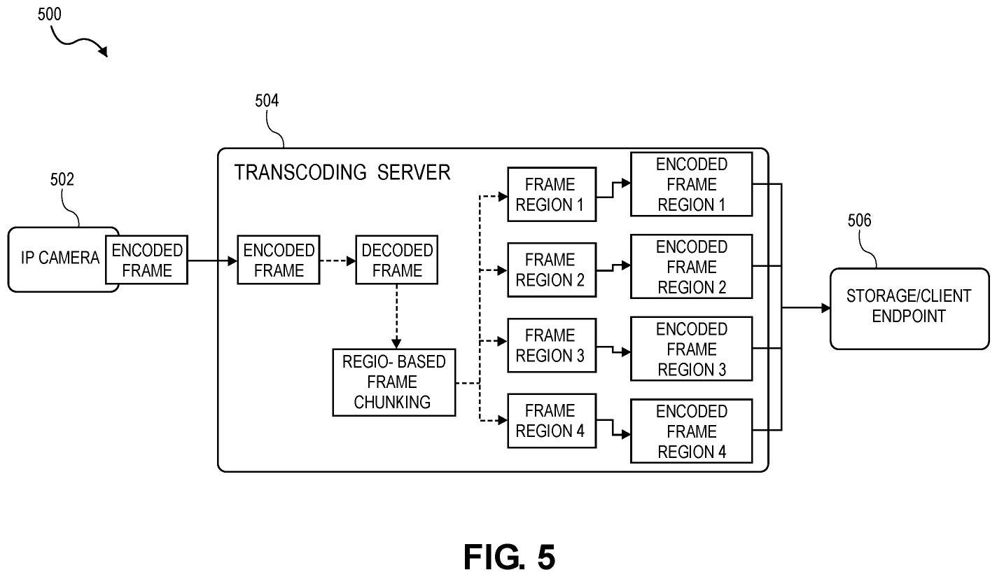

FIG. 5 illustrates an example of a centralized video transcoding system 500 that leverages frame chunking. In the illustrated example, an IP camera 502 sends an encoded frame of a video stream to a single transcoding server 504, which decodes the frame, partitions or “chunks” the decoded frame into subframes, and then encodes the subframes in parallel. The encoded subframes are then sent to a corresponding endpoint 506, such as a storage system or client device. This centralized transcoding system 500 is difficult to scale, however, as it must be scaled up (e.g., vertically scaled) rather than out (e.g., horizontally scaled) in order to handle an increasing number of requests to transcode video streams (e.g., due to an increasing number of video streams and/or an increasing number of transcoding requests from clients) while also satisfying the quality of service requirements (e.g., low latency). As a result, this centralized approach is not flexible from a total cost of ownership (TCO) perspective, as each transcoding server becomes a highly-customized special platform with a much higher cost.

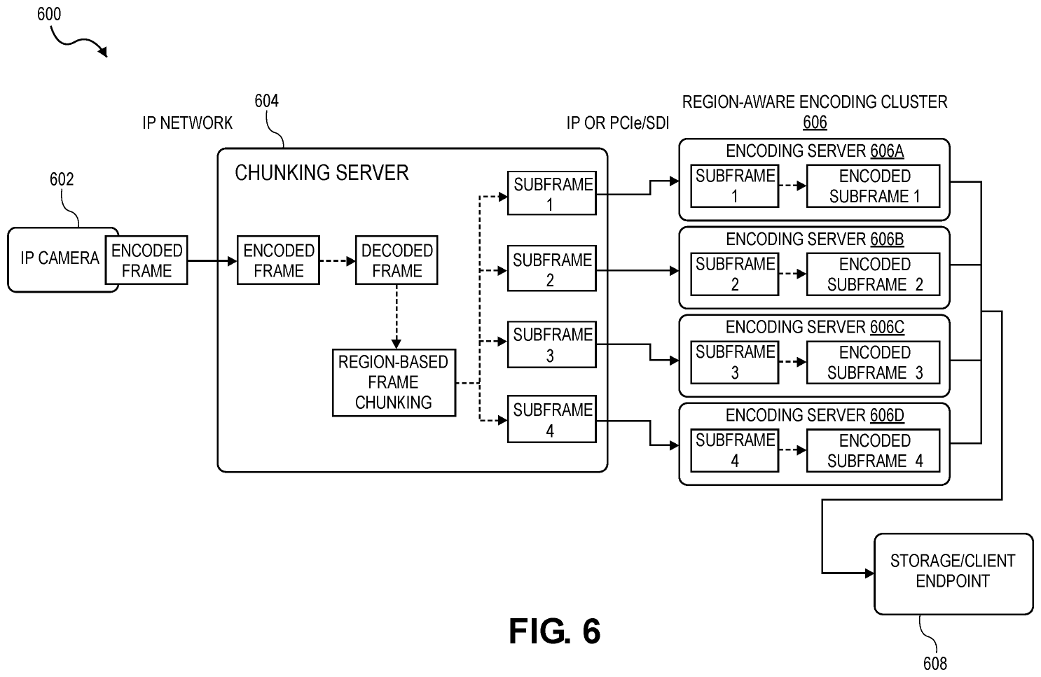

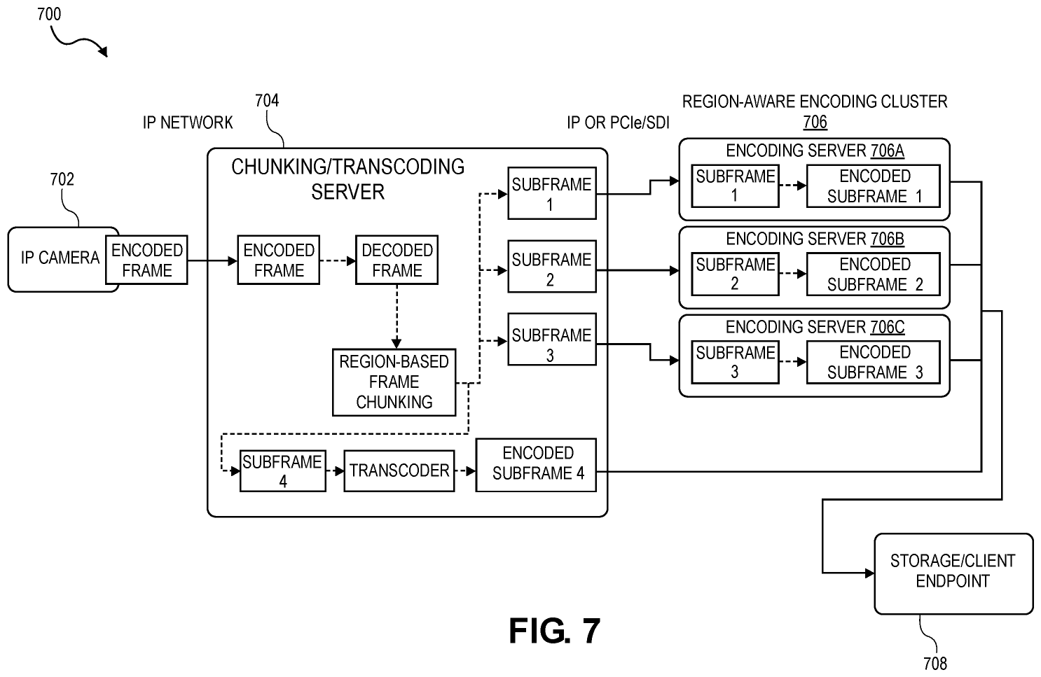

FIGS. 6-7 illustrate examples of distributed and parallel video transcoding systems that leverage frame chunking. These transcoding systems leverage a distributed architecture that allows the underlying chunking and encoding servers to be linearly scaled. In particular, the distributed architecture decouples the dependency between (i) partitioning or “chunking” a video frame into subframes and (ii) encoding/transcoding those subframes. For example, a chunking server is used to partition or “chunk” each frame of a video stream into a particular number of subframes (e.g., based on the level of parallelism required according to the usage of the video itself), and a cluster of encoding servers is then used to independently encode each subframe in parallel. In this manner, the cluster of encoding server instances can be dynamically managed and scaled independently to perform distributed encoding/transcoding for numerous videos streams and/or client devices while adhering to quality of service requirements.

FIG. 6 illustrates an example of a distributed and parallel video transcoding system 600 that leverages frame chunking. In the illustrated example, the video transcoding system 600 includes an IP camera 602, a chunking server 604, a region-aware encoding cluster 606, and a video stream endpoint 608 (e.g., a storage system or client device).

The IP camera 602 streams the frames of an encoded video stream to the chunking server 604. Upon receiving an encoded frame from the IP camera 602, the chunking server 604 decodes the frame, partitions or “chunks” the decoded frame into a particular number of raw subframes corresponding to non-overlapping spatial regions of the frame, and then concurrently sends the raw subframes to the cluster of encoding servers 606 to be encoded in parallel. In the illustrated embodiment, for example, a decoded frame is partitioned into four subframe regions, or “chunks,” which are independently encoded by different encoding servers 606a-d in the encoding cluster 606.

The number of subframes, however, can be configurable and/or dynamically adjusted based on the level of parallelism required for a particular video streaming application or use case (e.g., based on the usage of the video itself). For example, different types of video content can use different numbers of subframes or chunks to encode the underlying frames (e.g., video content that requires more compute to perform encoding may use a larger number of chunks or subframes to encode each frame).

Each subframe or “chunk” corresponds to a particular spatial region or slice of a raw/decoded video frame. The process of chunking is relatively straightforward and lightweight, and thus does not require substantial computing resources, as it primarily involves finding the subframe boundaries in a memory block that holds a raw/decoded frame. In some embodiments, for example, the chunking functionality may be completely offloaded to network interface controllers (NICs) that have streaming protocol offload support (e.g., smartNICs). Alternatively, for an input video stream that contains raw video (e.g., unencoded), the “chunking server” may be as simple a configurable video splitter that separates/re-groups each frame of the video stream into multiple subframe regions, which are delivered through different outputs to the encoding servers.

Moreover, in some embodiments, after a frame has been partitioned or chunked into subframes, the subframes may be multicast or broadcast to the encoding cluster with metadata or markers indicating the regions in the parent frame that correspond to the respective subframes. In this manner, the encoding servers receive all of the subframes of a parent frame, but each encoding server only handles the encoding of a particular subframe that corresponds to a designated frame region assigned to that encoding server. Moreover, even though the subframes are individually encoded by different encoding servers, it is possible for the subframes to be encoded with intra-frame dependencies since each encoding server has access to all of the subframes (e.g., thus improving the encoding efficiency while also maximizing parallelism).

FIG. 7 illustrates another example of a distributed and parallel video transcoding system 700 that leverages frame chunking. The components of video transcoding system 700 (e.g., IP camera 702, chunking server 704, region-aware encoding cluster 706, and video stream endpoint 708) may be similar to the corresponding components in video transcoding system 600 of FIG. 6. In video transcoding system 700, however, the chunking server 704 handles frame chunking and serves as one of the encoding servers in the encoding cluster 706. For example, after partitioning a decoded frame into subframes, the chunking server 704 performs the encoding for one of the subframes while concurrently sending the remaining subframes to the encoding cluster 706 to be encoded in parallel.

In the video transcoding systems 600, 700 of FIGS. 6 and 7, the interconnection between the chunking server and the cluster of encoding servers can be implemented using any suitable type of interconnect technology depending on the particular deployment requirements, such as IP, PCIe/SDI, or USB, among other examples. IP is a more scalable solution, as it enables more encoding servers to join the encoding cluster to perform the collaborative distributed encoding in parallel, but it may also require more datacenter rack space for switching units. Alternatively, PCIe/SDI or even external USB connections may be suitable when the chunking server and the encoding servers are physically located within the maximum cable distance.

Moreover, since the frame chunking and encoding are fundamentally decoupled, there are no requirements or dependencies on the front-end side of an incoming video stream, regardless of the type of content in the video stream or its source (e.g., live video from IP-based or CCTV-based cameras, or offline video served from existing storage systems).

Further, in some embodiments, each encoding server in the encoding cluster may include multiple hardware encoders to further increase the level of encoding parallelism. For example, an encoding server may utilize multiple hardware encoders to encode a particular subframe assigned to that encoding server (e.g., by partitioning the subframe into further chunks or regions that are encoded in parallel by the respective hardware encoders), or the encoding server may use multiple hardware encoders to encode multiple subframes from different video streams concurrently (e.g., by encoding a subframe from each video stream using a different hardware encoder).

This solution provides significant total cost of ownership (TCO) benefits for cloud service providers (CSPs) and content delivery network (CDN) providers. In particular, the number of subframes that are encoded in parallel for each frame of a given video stream can be configured and/or dynamically adjusted based on the unique requirements of that video stream. For example, for a real-time video gaming service that expects end-to-end latency of sub-100 ms, a video stream can be transcoded with very high parallelism by simply increasing the number of subframes or chunks that are independently encoded in parallel for each frame, which enables more encoding servers to concurrently work on the same video stream, thus reducing the overall latency. Moreover, when performing encoding or transcoding on many different video streams, this solution can be configured to treat certain streams with higher priority (e.g., higher parallelism) and others with lower priority (e.g., lower parallelism) by simply adjusting the number of subframes that are encoded in parallel for each video stream. This unique flexibility can greatly reduce the TCO for CSPs and CDN providers.

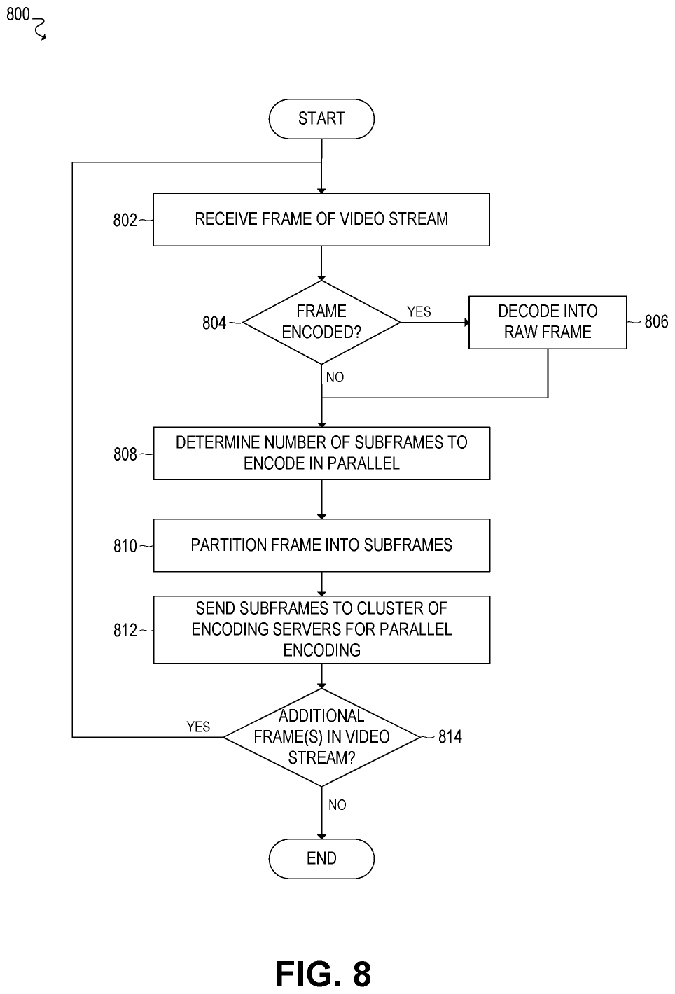

FIG. 8 illustrates a flowchart 800 for an example embodiment of distributed and parallel video stream encoding and transcoding. In various embodiments, flowchart 800 may be implemented using the embodiments described throughout this disclosure, such the chunking server of FIGS. 1, 4, 6, and/or 7. For example, the chunking server may include a communication interface and processing circuitry. In some embodiments, the communication interface and the processing circuitry of the chunking server could be fully or partially implemented on a special-purpose computing device or accelerator (e.g., a smart network interface controller (smartNIC), FPGA, or ASIC). Alternatively, the processing circuitry could be implemented on a general-purpose processor (e.g., an Intel x86 processor).

The flowchart begins at block 802, where a frame of a video stream is received by a chunking server (e.g., via a communication interface of the chunking server). For example, the chunking server may receive the frame from a camera, storage system, or server, among other examples.

The flowchart then proceeds to block 804 to determine whether the received frame is encoded. In some cases, for example, the frame may be a raw or unencoded frame, or the frame may be encoded with a default encoding scheme. If the received frame is encoded, the flowchart proceeds to block 806 to decode the encoded frame into a raw frame, and the flowchart then proceeds to block 808, as described further below. If the received frame is not encoded, the flowchart proceeds directly to block 808.

At block 808, the number of subframes to encode in parallel for the frame is determined or identified. In some embodiments, for example, the number of subframes may be determined based on various criteria, such as the type of video content within the video stream, the compute requirements for encoding that type of video content, quality of service requirements for streaming the video stream (e.g., maximum latency), and so forth.

The flowchart then proceeds to block 810, where the frame is partitioned into the particular number of subframes identified at block 808. For example, the subframes may correspond to non-overlapping spatial regions in the frame.

The flowchart then proceeds to block 812, where the subframes are concurrently sent (e.g., via a communication interface of the chunking server) to a cluster of encoding servers to be encoded in parallel.

In some embodiments, for example, the chunking server may multicast or broadcast the subframes to the cluster of encoding servers, or the chunking server may individually transmit each subframe to a corresponding encoding server in the cluster. Moreover, in some embodiments, the chunking server may send frame metadata to the cluster of encoding servers to indicate the positions of the subframes within the frame.

In this manner, each subframe may be encoded in parallel by a particular encoding server in the cluster. In some embodiments, the subframes may be independently encoded using the same video codec, or the subframes may be independently encoded using multiple video codecs (e.g., where each subframe is encoded with a particular video codec).

Moreover, in some embodiments, the chunking server may also serve as an encoding server, such that the chunking server handles the encoding of one of the subframes locally, while the remaining subframes are encoded in parallel by the cluster of encoding servers.

The flowchart then proceeds to block 814 to determine if there are additional frame(s) in the video stream. If there are additional frames in the video stream, the flowchart proceeds back to block 802 to continue receiving and encoding/transcoding the remaining frames. If there are no additional frames in the video stream, then the video stream has been fully encoded/transcoded, and thus the flowchart may be complete.

At this point, the flowchart may be complete. In some embodiments, however, the flowchart may restart and/or certain blocks may be repeated. For example, in some embodiments, the flowchart may restart at block 802 to continue receiving and encoding frames of other video streams.

Example Internet-of-Things (IoT) Implementations

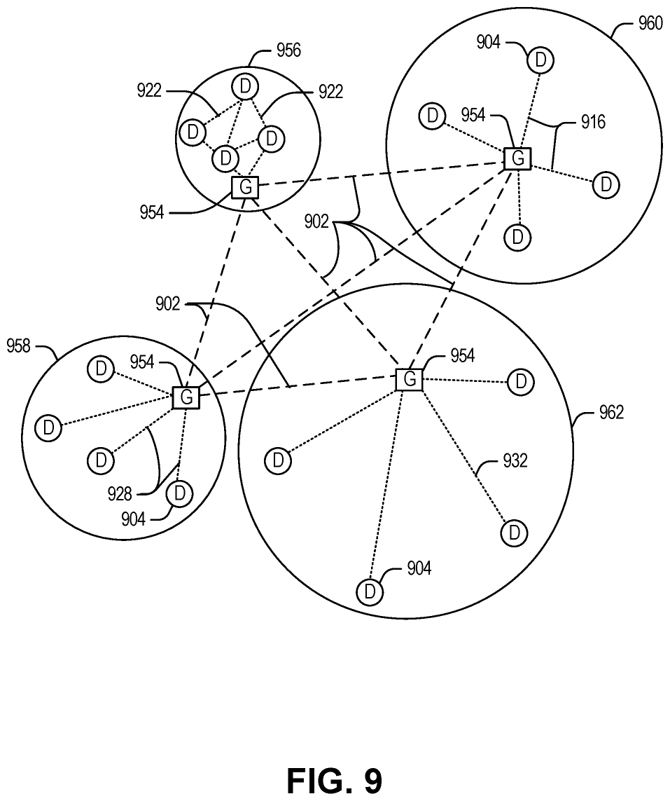

FIGS. 9-12 illustrate examples of Internet-of-Things (IoT) networks and devices that can be used in accordance with embodiments disclosed herein. For example, the operations and functionality described throughout this disclosure may be embodied by an IoT device or machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 9 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 9-12, present a number of new challenges in a heterogeneous network of connectivity comprising a combination of wired and wireless technologies.

FIG. 9 specifically provides a simplified drawing of a domain topology that may be used for a number of internet-of-things (IoT) networks comprising IoT devices 904, with the IoT networks 956, 958, 960, 962, coupled through backbone links 902 to respective gateways 954. For example, a number of IoT devices 904 may communicate with a gateway 954, and with each other through the gateway 954. To simplify the drawing, not every IoT device 904, or communications link (e.g., link 916, 922, 928, or 932) is labeled. The backbone links 902 may include any number of wired or wireless technologies, including optical networks, and may be part of a local area network (LAN), a wide area network (WAN), or the Internet. Additionally, such communication links facilitate optical signal paths among both IoT devices 904 and gateways 954, including the use of MUXing/deMUXing components that facilitate interconnection of the various devices.

The network topology may include any number of types of IoT networks, such as a mesh network provided with the network 956 using Bluetooth low energy (BLE) links 922. Other types of IoT networks that may be present include a wireless local area network (WLAN) network 958 used to communicate with IoT devices 904 through IEEE 802.11 (Wi-Fi®) links 928, a cellular network 960 used to communicate with IoT devices 904 through an LTE/LTE-A (4G) or 5G cellular network, and a low-power wide area (LPWA) network 962, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 904, such as over the backbone links 902, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 956, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 958, for instance, may use systems that perform standards conversion to provide multi-standard connectivity, enabling IoT devices 904 using different protocols to communicate. Further systems may provide seamless interconnectivity across a multi-standard infrastructure comprising visible Internet resources and hidden Internet resources.

Communications in the cellular network 960, for instance, may be enhanced by systems that offload data, extend communications to more remote devices, or both. The LPWA network 962 may include systems that perform non-Internet protocol (IP) to IP interconnections, addressing, and routing. Further, each of the IoT devices 904 may include the appropriate transceiver for wide area communications with that device. Further, each IoT device 904 may include other transceivers for communications using additional protocols and frequencies.

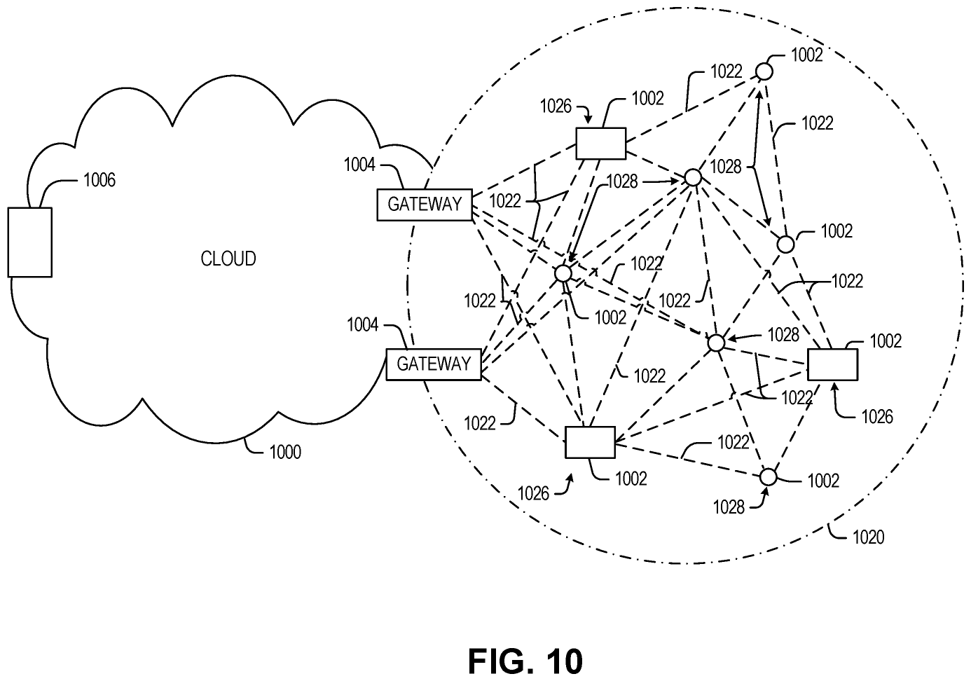

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 10 below.

FIG. 10 illustrates a cloud computing network in communication with a mesh network of IoT devices (devices 1002) operating as a fog device at the edge of the cloud computing network. The mesh network of IoT devices may be termed a fog 1020, operating at the edge of the cloud 1000. To simplify the diagram, not every IoT device 1002 is labeled.

The fog 1020 may be considered to be a massively interconnected network wherein a number of IoT devices 1002 are in communications with each other, for example, by radio links 1022. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 1002 are shown in this example, gateways 1004, data aggregators 1026, and sensors 1028, although any combinations of IoT devices 1002 and functionality may be used. The gateways 1004 may be edge devices that provide communications between the cloud 1000 and the fog 1020, and may also provide the backend process function for data obtained from sensors 1028, such as motion data, flow data, temperature data, and the like. The data aggregators 1026 may collect data from any number of the sensors 1028, and perform the back-end processing function for the analysis. The results, raw data, or both may be passed along to the cloud 1000 through the gateways 1004. The sensors 1028 may be full IoT devices 1002, for example, capable of both collecting data and processing the data. In some cases, the sensors 1028 may be more limited in functionality, for example, collecting the data and allowing the data aggregators 1026 or gateways 1004 to process the data.

Communications from any IoT device 1002 may be passed along a convenient path (e.g., a most convenient path) between any of the IoT devices 1002 to reach the gateways 1004. In these networks, the number of interconnections provide substantial redundancy, allowing communications to be maintained, even with the loss of a number of IoT devices 1002. Further, the use of a mesh network may allow IoT devices 1002 that are very low power or located at a distance from infrastructure to be used, as the range to connect to another IoT device 1002 may be much less than the range to connect to the gateways 1004.

The fog 1020 provided from these IoT devices 1002 may be presented to devices in the cloud 1000, such as a server 1006, as a single device located at the edge of the cloud 1000, e.g., a fog device. In this example, the alerts coming from the fog device may be sent without being identified as coming from a specific IoT device 1002 within the fog 1020. In this fashion, the fog 1020 may be considered a distributed platform that provides computing and storage resources to perform processing or data-intensive tasks such as data analytics, data aggregation, and machine-learning, among others.

In some examples, the IoT devices 1002 may be configured using an imperative programming style, e.g., with each IoT device 1002 having a specific function and communication partners. However, the IoT devices 1002 forming the fog device may be configured in a declarative programming style, allowing the IoT devices 1002 to reconfigure their operations and communications, such as to determine needed resources in response to conditions, queries, and device failures. As an example, a query from a user located at a server 1006 about the operations of a subset of equipment monitored by the IoT devices 1002 may result in the fog 1020 device selecting the IoT devices 1002, such as particular sensors 1028, needed to answer the query. The data from these sensors 1028 may then be aggregated and analyzed by any combination of the sensors 1028, data aggregators 1026, or gateways 1004, before being sent on by the fog 1020 device to the server 1006 to answer the query. In this example, IoT devices 1002 in the fog 1020 may select the sensors 1028 used based on the query, such as adding data from flow sensors or temperature sensors. Further, if some of the IoT devices 1002 are not operational, other IoT devices 1002 in the fog 1020 device may provide analogous data, if available.

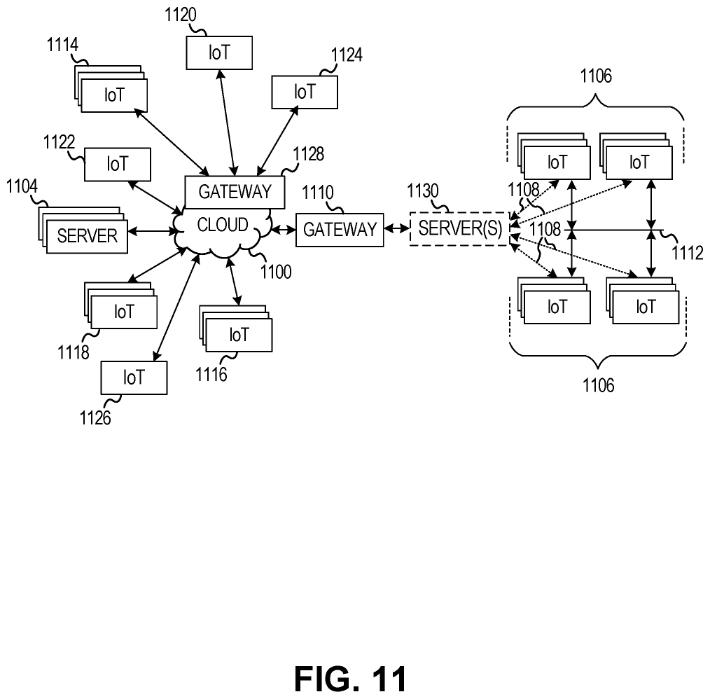

FIG. 11 illustrates a drawing of a cloud computing network, or cloud 1100, in communication with a number of Internet of Things (IoT) devices. The cloud 1100 may represent the Internet, or may be a local area network (LAN), or a wide area network (WAN), such as a proprietary network for a company. The IoT devices may include any number of different types of devices, grouped in various combinations. For example, a traffic control group 1106 may include IoT devices along streets in a city. These IoT devices may include stoplights, traffic flow monitors, cameras, weather sensors, and the like. The traffic control group 1106, or other subgroups, may be in communication with the cloud 1100 through wired or wireless links 1108, such as LPWA links, optical links, and the like. Further, a wired or wireless sub-network 1112 may allow the IoT devices to communicate with each other, such as through a local area network, a wireless local area network, and the like. The IoT devices may use another device, such as a gateway 1110 or 1128 to communicate with remote locations such as the cloud 1100; the IoT devices may also use one or more servers 1130 to facilitate communication with the cloud 1100 or with the gateway 1110. For example, the one or more servers 1130 may operate as an intermediate network node to support a local edge cloud or fog implementation among a local area network. Further, the gateway 1128 that is depicted may operate in a cloud-to-gateway-to-many edge devices configuration, such as with the various IoT devices 1114, 1120, 1124 being constrained or dynamic to an assignment and use of resources in the cloud 1100.

Other example groups of IoT devices may include remote weather stations 1114, local information terminals 1116, alarm systems 1118, automated teller machines 1120, alarm panels 1122, or moving vehicles, such as emergency vehicles 1124 or other vehicles 1126, among many others. Each of these IoT devices may be in communication with other IoT devices, with servers 1104, with another IoT fog device or system (not shown, but depicted in FIG. 10), or a combination therein. The groups of IoT devices may be deployed in various residential, commercial, and industrial settings (including in both private or public environments).

As can be seen from FIG. 11, a large number of IoT devices may be communicating through the cloud 1100. This may allow different IoT devices to request or provide information to other devices autonomously. For example, a group of IoT devices (e.g., the traffic control group 1106) may request a current weather forecast from a group of remote weather stations 1114, which may provide the forecast without human intervention. Further, an emergency vehicle 1124 may be alerted by an automated teller machine 1120 that a burglary is in progress. As the emergency vehicle 1124 proceeds towards the automated teller machine 1120, it may access the traffic control group 1106 to request clearance to the location, for example, by lights turning red to block cross traffic at an intersection in sufficient time for the emergency vehicle 1124 to have unimpeded access to the intersection.

Clusters of IoT devices, such as the remote weather stations 1114 or the traffic control group 1106, may be equipped to communicate with other IoT devices as well as with the cloud 1100. This may allow the IoT devices to form an ad-hoc network between the devices, allowing them to function as a single device, which may be termed a fog device or system (e.g., as described above with reference to FIG. 10).

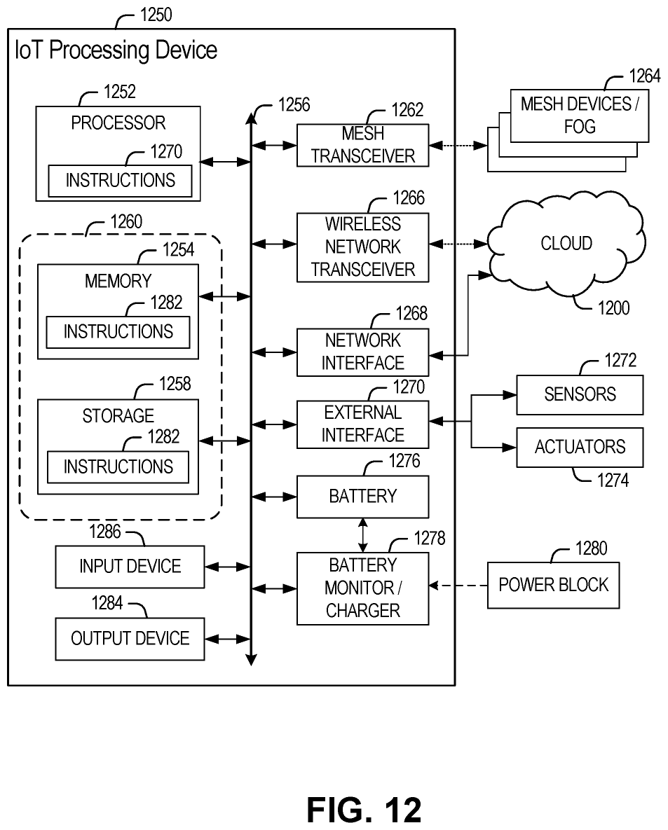

FIG. 12 is a block diagram of an example of components that may be present in an IoT device 1250 for implementing the techniques described herein. The IoT device 1250 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1250, or as components otherwise incorporated within a chassis of a larger system. Additionally, the block diagram of FIG. 12 is intended to depict a high-level view of components of the IoT device 1250. However, some of the components shown may be omitted, additional components may be present, and different arrangement of the components shown may occur in other implementations.

The IoT device 1250 may include a processor 1252, which may be a microprocessor, a multi-core processor, a multithreaded processor, an ultra-low voltage processor, an embedded processor, or other known processing element. The processor 1252 may be a part of a system on a chip (SoC) in which the processor 1252 and other components are formed into a single integrated circuit, or a single package, such as the Edison™ or Galileo™ SoC boards from Intel. As an example, the processor 1252 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 1252 may communicate with a system memory 1254 over an interconnect 1256 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1258 may also couple to the processor 1252 via the interconnect 1256. In an example, the storage 1258 may be implemented via a solid state disk drive (SSDD). Other devices that may be used for the storage 1258 include flash memory cards, such as SD cards, microSD cards, xD picture cards, and the like, and USB flash drives. In low power implementations, the storage 1258 may be on-die memory or registers associated with the processor 1252. However, in some examples, the storage 1258 may be implemented using a micro hard disk drive (HDD). Further, any number of new technologies may be used for the storage 1258 in addition to, or instead of, the technologies described, such resistance change memories, phase change memories, holographic memories, or chemical memories, among others.

The components may communicate over the interconnect 1256. The interconnect 1256 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1256 may be a proprietary bus, for example, used in a SoC based system. Other bus systems may be included, such as an I2C interface, an SPI interface, point to point interfaces, and a power bus, among others.

The interconnect 1256 may couple the processor 1252 to a mesh transceiver 1262, for communications with other mesh devices 1264. The mesh transceiver 1262 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1264. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1262 may communicate using multiple standards or radios for communications at different range. For example, the IoT device 1250 may communicate with close devices, e.g., within about 10 meters, using a local transceiver based on BLE, or another low power radio, to save power. More distant mesh devices 1264, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1266 may be included to communicate with devices or services in the cloud 1200 via local or wide area network protocols. The wireless network transceiver 1266 may be a LPWA transceiver that follows the IEEE 802.15.4, or IEEE 802.15.4g standards, among others. The IoT device 1250 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1262 and wireless network transceiver 1266, as described herein. For example, the radio transceivers 1262 and 1266 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 1262 and 1266 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1266, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1268 may be included to provide a wired communication to the cloud 1200 or to other devices, such as the mesh devices 1264. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1268 may be included to allow connect to a second network, for example, a NIC 1268 providing communications to the cloud over Ethernet, and a second NIC 1268 providing communications to other devices over another type of network.

The interconnect 1256 may couple the processor 1252 to an external interface 1270 that is used to connect external devices or subsystems. The external devices may include sensors 1272, such as accelerometers, level sensors, flow sensors, optical light sensors, camera sensors, temperature sensors, a global positioning system (GPS) sensors, pressure sensors, barometric pressure sensors, and the like. The external interface 1270 further may be used to connect the IoT device 1250 to actuators 1274, such as power switches, valve actuators, an audible sound generator, a visual warning device, and the like.

In some optional examples, various input/output (I/O) devices may be present within, or connected to, the IoT device 1250. For example, a display or other output device 1284 may be included to show information, such as sensor readings or actuator position. An input device 1286, such as a touch screen or keypad may be included to accept input. An output device 1284 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1250.

A battery 1276 may power the IoT device 1250, although in examples in which the IoT device 1250 is mounted in a fixed location, it may have a power supply coupled to an electrical grid. The battery 1276 may be a lithium ion battery, or a metal-air battery, such as a zinc-air battery, an aluminum-air battery, a lithium-air battery, and the like.

A battery monitor/charger 1278 may be included in the IoT device 1250 to track the state of charge (SoCh) of the battery 1276. The battery monitor/charger 1278 may be used to monitor other parameters of the battery 1276 to provide failure predictions, such as the state of health (SoH) and the state of function (SoF) of the battery 1276. The battery monitor/charger 1278 may include a battery monitoring integrated circuit, such as an LTC4020 or an LTC2790 from Linear Technologies, an ADT7488A from ON Semiconductor of Phoenix Ariz., or an IC from the UCD90xxx family from Texas Instruments of Dallas, Tex. The battery monitor/charger 1278 may communicate the information on the battery 1276 to the processor 1252 over the interconnect 1256. The battery monitor/charger 1278 may also include an analog-to-digital (ADC) convertor that allows the processor 1252 to directly monitor the voltage of the battery 1276 or the current flow from the battery 1276. The battery parameters may be used to determine actions that the IoT device 1250 may perform, such as transmission frequency, mesh network operation, sensing frequency, and the like.

A power block 1280, or other power supply coupled to a grid, may be coupled with the battery monitor/charger 1278 to charge the battery 1276. In some examples, the power block 1280 may be replaced with a wireless power receiver to obtain the power wirelessly, for example, through a loop antenna in the IoT device 1250. A wireless battery charging circuit, such as an LTC4020 chip from Linear Technologies of Milpitas, Calif., among others, may be included in the battery monitor/charger 1278. The specific charging circuits chosen depend on the size of the battery 1276, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1258 may include instructions 1282 in the form of software, firmware, or hardware commands to implement the techniques described herein. Although such instructions 1282 are shown as code blocks included in the memory 1254 and the storage 1258, it may be understood that any of the code blocks may be replaced with hardwired circuits, for example, built into an application specific integrated circuit (ASIC).

In an example, the instructions 1282 provided via the memory 1254, the storage 1258, or the processor 1252 may be embodied as a non-transitory, machine readable medium 1260 including code to direct the processor 1252 to perform electronic operations in the IoT device 1250. The processor 1252 may access the non-transitory, machine readable medium 1260 over the interconnect 1256. For instance, the non-transitory, machine readable medium 1260 may include storage units such as optical disks, flash drives, or any number of other hardware devices. The non-transitory, machine readable medium 1260 may include instructions to direct the processor 1252 to perform a specific sequence or flow of actions, for example, as described with respect to the flowchart(s) and diagram(s) of operations and functionality described throughout this disclosure.

Example Computing Architectures

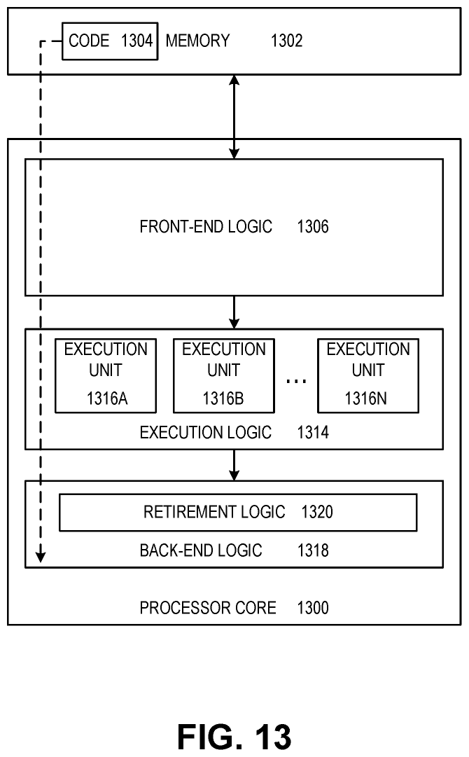

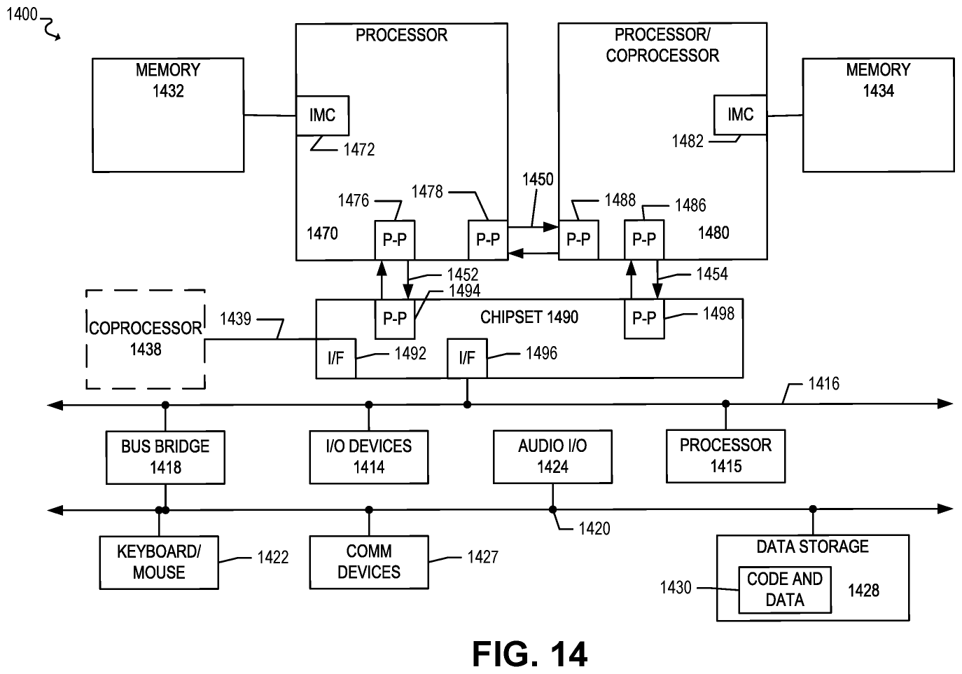

FIGS. 13 and 14 illustrate example computer processor architectures that can be used in accordance with embodiments disclosed herein. For example, in various embodiments, the computer architectures of FIGS. 13 and 14 may be used to implement the functionality described throughout this disclosure. Other embodiments may use other processor and system designs and configurations known in the art, for example, for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

FIG. 13 illustrates a block diagram for an example embodiment of a processor 1300. Processor 1300 is an example of a type of hardware device that can be used in connection with the embodiments described throughout this disclosure. Processor 1300 may be any type of processor, such as a microprocessor, an embedded processor, a digital signal processor (DSP), a network processor, a multi-core processor, a single core processor, or other device to execute code. Although only one processor 1300 is illustrated in FIG. 13, a processing element may alternatively include more than one of processor 1300 illustrated in FIG. 13. Processor 1300 may be a single-threaded core or, for at least one embodiment, the processor 1300 may be multi-threaded in that it may include more than one hardware thread context (or “logical processor”) per core.

FIG. 13 also illustrates a memory 1302 coupled to processor 1300 in accordance with an embodiment. Memory 1302 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 1300 can execute any type of instructions associated with algorithms, processes, or operations detailed herein. Generally, processor 1300 can transform an element or an article (e.g., data) from one state or thing to another state or thing.

Code 1304, which may be one or more instructions to be executed by processor 1300, may be stored in memory 1302, or may be stored in software, hardware, firmware, or any suitable combination thereof, or in any other internal or external component, device, element, or object where appropriate and based on particular needs. In one example, processor 1300 can follow a program sequence of instructions indicated by code 1304. Each instruction enters a front-end logic 1306 and is processed by one or more decoders 1308. The decoder may generate, as its output, a micro operation such as a fixed width micro operation in a predefined format, or may generate other instructions, microinstructions, or control signals that reflect the original code instruction. Front-end logic 1306 may also include register renaming logic and scheduling logic, which generally allocate resources and queue the operation corresponding to the instruction for execution.

Processor 1300 can also include execution logic 1314 having a set of execution units 1316a, 1316b, 1316n, etc. Some embodiments may include a number of execution units dedicated to specific functions or sets of functions. Other embodiments may include only one execution unit or one execution unit that can perform a particular function. Execution logic 1314 performs the operations specified by code instructions.

After completion of execution of the operations specified by the code instructions, back-end logic 1318 can retire the instructions of code 1304. In one embodiment, processor 1300 allows out of order execution but requires in order retirement of instructions. Retirement logic 1320 may take a variety of known forms (e.g., re-order buffers or the like). In this manner, processor 1300 is transformed during execution of code 1304, at least in terms of the output generated by the decoder, hardware registers and tables utilized by register renaming logic 1310, and any registers (not shown) modified by execution logic 1314.

Although not shown in FIG. 13, a processing element may include other elements on a chip with processor 1300. For example, a processing element may include memory control logic along with processor 1300. The processing element may include I/O control logic and/or may include I/O control logic integrated with memory control logic. The processing element may also include one or more caches. In some embodiments, non-volatile memory (such as flash memory or fuses) may also be included on the chip with processor 1300.

FIG. 14 illustrates a block diagram for an example embodiment of a multiprocessor 1400. As shown in FIG. 14, multiprocessor system 1400 is a point-to-point interconnect system, and includes a first processor 1470 and a second processor 1480 coupled via a point-to-point interconnect 1450. In some embodiments, each of processors 1470 and 1480 may be some version of processor 1300 of FIG. 13.

Processors 1470 and 1480 are shown including integrated memory controller (IMC) units 1472 and 1482, respectively. Processor 1470 also includes as part of its bus controller units point-to-point (P-P) interfaces 1476 and 1478; similarly, second processor 1480 includes P-P interfaces 1486 and 1488. Processors 1470, 1480 may exchange information via a point-to-point (P-P) interface 1450 using P-P interface circuits 1478, 1488. As shown in FIG. 14, IMCs 1472 and 1482 couple the processors to respective memories, namely a memory 1432 and a memory 1434, which may be portions of main memory locally attached to the respective processors.

Processors 1470, 1480 may each exchange information with a chipset 1490 via individual P-P interfaces 1452, 1454 using point to point interface circuits 1476, 1494, 1486, 1498. Chipset 1490 may optionally exchange information with the coprocessor 1438 via a high-performance interface 1439. In one embodiment, the coprocessor 1438 is a special-purpose processor, such as, for example, a high-throughput MIC processor, a network or communication processor, compression engine, graphics processor, GPGPU, embedded processor, matrix processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1490 may be coupled to a first bus 1416 via an interface 1496. In one embodiment, first bus 1416 may be a Peripheral Component Interconnect (PCI) bus, or a bus such as a PCI Express bus or another third generation I/O interconnect bus, although the scope of this disclosure is not so limited.

As shown in FIG. 14, various I/O devices 1414 may be coupled to first bus 1416, along with a bus bridge 1418 which couples first bus 1416 to a second bus 1420. In one embodiment, one or more additional processor(s) 1415, such as coprocessors, high-throughput MIC processors, GPGPU's, accelerators (such as, e.g., graphics accelerators or digital signal processing (DSP) units), matrix processors, field programmable gate arrays, or any other processor, are coupled to first bus 1416. In one embodiment, second bus 1420 may be a low pin count (LPC) bus. Various devices may be coupled to a second bus 1420 including, for example, a keyboard and/or mouse 1422, communication devices 1427 and a storage unit 1428 such as a disk drive or other mass storage device which may include instructions/code and data 1430, in one embodiment. Further, an audio I/O 1424 may be coupled to the second bus 1420. Note that other architectures are possible. For example, instead of the point-to-point architecture of FIG. 14, a system may implement a multi-drop bus or other such architecture.

All or part of any component of FIG. 14 may be implemented as a separate or stand-alone component or chip, or may be integrated with other components or chips, such as a system-on-a-chip (SoC) that integrates various computer components into a single chip.

Embodiments of the mechanisms disclosed herein may be implemented in hardware, software, firmware, or a combination of such implementation approaches. Certain embodiments may be implemented as computer programs or program code executing on programmable systems comprising at least one processor, a storage system (including volatile and non-volatile memory and/or storage elements), at least one input device, and at least one output device.

Program code, such as code 1430 illustrated in FIG. 14, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of this disclosure also include non-transitory, tangible machine-readable media containing instructions or containing design data, such as Hardware Description Language (HDL), which defines structures, circuits, apparatuses, processors and/or system features described herein. Such embodiments may also be referred to as program products.

The machine-readable instructions described herein may be stored in one or more of a compressed format, an encrypted format, a fragmented format, a packaged format, etc. Machine readable instructions as described herein may be stored as data (e.g., portions of instructions, code, representations of code, etc.) that may be utilized to create, manufacture, and/or produce machine executable instructions. For example, the machine-readable instructions may be fragmented and stored on one or more storage devices and/or computing devices (e.g., servers). The machine-readable instructions may require one or more of installation, modification, adaptation, updating, combining, supplementing, configuring, decryption, decompression, unpacking, distribution, reassignment, etc. in order to make them directly readable and/or executable by a computing device and/or other machine. For example, the machine-readable instructions may be stored in multiple parts, which are individually compressed, encrypted, and stored on separate computing devices, wherein the parts when decrypted, decompressed, and combined form a set of executable instructions that implement a program such as that described herein. In another example, the machine-readable instructions may be stored in a state in which they may be read by a computer, but require addition of a library (e.g., a dynamic link library), a software development kit (SDK), an application programming interface (API), etc. in order to execute the instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, the disclosed machine-readable instructions and/or corresponding program(s) are intended to encompass such machine-readable instructions and/or program(s) regardless of the particular format or state of the machine readable instructions and/or program(s) when stored or otherwise at rest or in transit.

The flowcharts and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The foregoing disclosure outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

As used throughout this specification, the term “processor” or “microprocessor” should be understood to include not only a traditional microprocessor (such as Intel's° industry-leading x86 and x64 architectures), but also graphics processors, matrix processors, and any ASIC, FPGA, microcontroller, digital signal processor (DSP), programmable logic device, programmable logic array (PLA), microcode, instruction set, emulated or virtual machine processor, or any similar “Turing-complete” device, combination of devices, or logic elements (hardware or software) that permit the execution of instructions.

Note also that in certain embodiments, some of the components may be omitted or consolidated. In a general sense, the arrangements depicted in the figures should be understood as logical divisions, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute instructions associated with data or microcode to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, a storage may store information in any suitable type of tangible, non-transitory storage medium (for example, random access memory (RAM), read only memory (ROM), field programmable gate array (FPGA), erasable programmable read only memory (EPROM), electrically erasable programmable ROM (EEPROM), or microcode), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein should be construed as being encompassed within the broad terms ‘memory’ and ‘storage,’ as appropriate. A non-transitory storage medium herein is expressly intended to include any non-transitory special-purpose or programmable hardware configured to provide the disclosed operations, or to cause a processor to perform the disclosed operations. A non-transitory storage medium also expressly includes a processor having stored thereon hardware-coded instructions, and optionally microcode instructions or sequences encoded in hardware, firmware, or software.

Computer program logic implementing all or part of the functionality described herein is embodied in various forms, including, but in no way limited to, hardware description language, a source code form, a computer executable form, machine instructions or microcode, programmable hardware, and various intermediate forms (for example, forms generated by an HDL processor, assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

Example Implementations

The following examples pertain to embodiments described throughout this disclosure.

One or more embodiments may include an apparatus, comprising: a communication interface; and processing circuitry to: receive, via the communication interface, a frame of a video stream; determine a number of subframes to be encoded in parallel for the frame; partition the frame into a plurality of subframes based on the number of subframes to be encoded in parallel; and send, via the communication interface, the plurality of subframes to a cluster of encoding servers, wherein the cluster of encoding servers is to encode the plurality of subframes in parallel, and wherein each subframe of the plurality of subframes is to be encoded by a particular encoding server of the cluster of encoding servers.

In one example embodiment of an apparatus: the frame comprises an encoded frame; and the processing circuitry to partition the frame into the plurality of subframes based on the number of subframes to be encoded in parallel is further to: decode the encoded frame into a raw frame; and partition the raw frame into the plurality of subframes.

In one example embodiment of an apparatus, the processing circuitry to determine the number of subframes to be encoded in parallel for the frame is further to: determine the number of subframes to be encoded in parallel based at least in part on a type of video content within the video stream.

In one example embodiment of an apparatus, the processing circuitry to determine the number of subframes to be encoded in parallel based on the type of video content within the video stream is further to: determine the number of subframes to be encoded in parallel based at least in part on a compute requirement for encoding the type of video content within the video stream.

In one example embodiment of an apparatus, the processing circuitry to determine the number of subframes to be encoded in parallel for the frame is further to: determine the number of subframes to be encoded in parallel based at least in part on a quality of service requirement associated with streaming the video stream.

In one example embodiment of an apparatus, the quality of service requirement comprises a maximum latency associated with streaming the video stream.

In one example embodiment of an apparatus, the processing circuitry to send, via the communication interface, the plurality of subframes to the cluster of encoding servers is further to: multicast the plurality of subframes to the cluster of encoding servers.

In one example embodiment of an apparatus, the processing circuitry to send, via the communication interface, the plurality of subframes to the cluster of encoding servers is further to: send, via the communication interface, frame metadata to the cluster of encoding servers, wherein the frame metadata is to indicate positions of the plurality of subframes within the frame.

In one example embodiment of an apparatus, the processing circuitry is further to: partition the frame into one or more subframes to be encoded locally; and encode the one or more subframes in parallel with the plurality of subframes encoded by the cluster of encoding servers.

In one example embodiment of an apparatus, the cluster of encoding servers is to encode the plurality of subframes using a plurality of video codecs, wherein each subframe of the plurality of subframes is to be encoded using a particular video codec of the plurality of video codecs.

In one example embodiment of an apparatus, the apparatus further comprises: a smart network interface controller, wherein the smart network interface controller comprises the communication interface and the processing circuitry.

One or more embodiments may include at least one non-transitory machine accessible storage medium having instructions stored thereon, wherein the instructions, when executed on a machine, cause the machine to: receive, via a communication interface, a frame of a video stream; determine a number of subframes to be encoded in parallel for the frame; partition the frame into a plurality of subframes based on the number of subframes to be encoded in parallel; and send, via the communication interface, the plurality of subframes to a cluster of encoding servers, wherein the cluster of encoding servers is to encode the plurality of subframes in parallel, and wherein each subframe of the plurality of subframes is to be encoded by a particular encoding server of the cluster of encoding servers.

In one example embodiment of a storage medium: the frame comprises an encoded frame; and the instructions that cause the machine to partition the frame into the plurality of subframes based on the number of subframes to be encoded in parallel further cause the machine to: decode the encoded frame into a raw frame; and partition the raw frame into the plurality of subframes.

In one example embodiment of a storage medium, the instructions that cause the machine to determine the number of subframes to be encoded in parallel for the frame further cause the machine to: determine the number of subframes to be encoded in parallel based at least in part on: a type of video content within the video stream; and a compute requirement for encoding the type of video content within the video stream.

In one example embodiment of a storage medium, the instructions that cause the machine to send, via the communication interface, the plurality of subframes to the cluster of encoding servers further cause the machine to: send, via the communication interface, frame metadata to the cluster of encoding servers, wherein the frame metadata is to indicate positions of the plurality of subframes within the frame.

In one example embodiment of a storage medium, the instructions further cause the machine to: partition the frame into one or more subframes to be encoded locally; and encode the one or more subframes in parallel with the plurality of subframes encoded by the cluster of encoding servers.

In one example embodiment of a storage medium, the cluster of encoding servers is to encode the plurality of subframes using a plurality of video codecs, wherein each subframe of the plurality of subframes is to be encoded using a particular video codec of the plurality of video codecs.

One or more embodiments may include a method, comprising: receiving, via a communication interface, a frame of a video stream; determining a number of subframes to be encoded in parallel for the frame; partitioning the frame into a plurality of subframes based on the number of subframes to be encoded in parallel; and sending, via the communication interface, the plurality of subframes to a cluster of encoding servers, wherein the cluster of encoding servers is to encode the plurality of subframes in parallel, and wherein each subframe of the plurality of subframes is to be encoded by a particular encoding server of the cluster of encoding servers.

In one example embodiment of a method: the frame comprises an encoded frame; and partitioning the frame into the plurality of subframes based on the number of subframes to be encoded in parallel comprises: decoding the encoded frame into a raw frame; and partitioning the raw frame into the plurality of subframes.

In one example embodiment of a method, determining the number of subframes to be encoded in parallel for the frame comprises: determining the number of subframes to be encoded in parallel based on: a type of video content within the video stream; and a compute requirement for encoding the type of video content within the video stream.

In one example embodiment of a method, the method further comprises: partitioning the frame into one or more subframes to be encoded locally; and encoding the one or more subframes in parallel with the plurality of subframes encoded by the cluster of encoding servers.

In one example embodiment of a method, the cluster of encoding servers is to encode the plurality of subframes using a plurality of video codecs, wherein each subframe of the plurality of subframes is to be encoded using a particular video codec of the plurality of video codecs.

One or more embodiments may include a system, comprising: a frame chunking server, wherein the frame chunking server comprises circuitry to: receive, via a network, a frame of a video stream; determine a number of subframes to be encoded in parallel for the frame; partition the frame into a plurality of subframes based on the number of subframes to be encoded in parallel; and send, via the network, the plurality of subframes to a cluster of encoding servers; and the cluster of encoding servers, wherein the cluster of encoding servers comprises circuitry to: receive, via the network, the plurality of subframes from the frame chunking server; encode the plurality of subframes into a plurality of encoded subframes using one or more video codecs, wherein the plurality of subframes is to be encoded by the cluster of encoding servers in parallel, and wherein each subframe of the plurality of subframes is to be encoded by a particular encoding server of the cluster of encoding servers; and send, via the network, the plurality of encoded subframes to a network destination corresponding to the video stream.

In one example embodiment of a system, each encoding server of the cluster of encoding servers comprises one or more hardware video encoders to encode one or more subframes of the plurality of subframes.

In one example embodiment of a system, the network destination comprises a storage server, wherein the storage server comprises a data storage device to store the plurality of encoded subframes.

What is claimed is:

1. An apparatus, comprising:
a communication interface; and
processing circuitry to:
receive, via the communication interface, a frame of a video stream;
determine a number of subframes to be encoded in parallel for the frame;
partition the frame into a plurality of subframes based on the number of subframes to be encoded in parallel; and
send, via the communication interface, the plurality of subframes to a cluster of encoding servers, wherein the cluster of encoding servers is to encode the plurality of subframes in parallel, and wherein each subframe of the plurality of subframes is to be encoded by a particular encoding server of the cluster of encoding servers.

2. The apparatus of claim 1, wherein:
the frame comprises an encoded frame; and
the processing circuitry to partition the frame into the plurality of subframes based on the number of subframes to be encoded in parallel is further to:
decode the encoded frame into a raw frame; and
partition the raw frame into the plurality of subframes.

3. The apparatus of claim 1, wherein the processing circuitry to determine the number of subframes to be encoded in parallel for the frame is further to:
determine the number of subframes to be encoded in parallel based at least in part on a type of video content within the video stream.

4. The apparatus of claim 3, wherein the processing circuitry to determine the number of subframes to be encoded in parallel based on the type of video content within the video stream is further to:
determine the number of subframes to be encoded in parallel based at least in part on a compute requirement for encoding the type of video content within the video stream.

5. The apparatus of claim 1, wherein the processing circuitry to determine the number of subframes to be encoded in parallel for the frame is further to:
determine the number of subframes to be encoded in parallel based at least in part on a quality of service requirement associated with streaming the video stream.

6. The apparatus of claim 5, wherein the quality of service requirement comprises a maximum latency associated with streaming the video stream.

7. The apparatus of claim 1, wherein the processing circuitry to send, via the communication interface, the plurality of subframes to the cluster of encoding servers is further to:
multicast the plurality of subframes to the cluster of encoding servers.

8. The apparatus of claim 1, wherein the processing circuitry to send, via the communication interface, the plurality of subframes to the cluster of encoding servers is further to:
send, via the communication interface, frame metadata to the cluster of encoding servers, wherein the frame metadata is to indicate positions of the plurality of subframes within the frame.

9. The apparatus of claim 1, wherein the processing circuitry is further to:
partition the frame into one or more subframes to be encoded locally; and
encode the one or more subframes in parallel with the plurality of subframes encoded by the cluster of encoding servers.

10. The apparatus of claim 1, wherein the cluster of encoding servers is to encode the plurality of subframes using a plurality of video codecs, wherein each subframe of the plurality of subframes is to be encoded using a particular video codec of the plurality of video codecs.

11. The apparatus of claim 1, further comprising:
a smart network interface controller, wherein the smart network interface controller comprises the communication interface and the processing circuitry.

12. At least one non-transitory machine accessible storage medium having instructions stored thereon, wherein the instructions, when executed on a machine, cause the machine to:
receive, via a communication interface, a frame of a video stream;
determine a number of subframes to be encoded in parallel for the frame;
partition the frame into a plurality of subframes based on the number of subframes to be encoded in parallel; and
send, via the communication interface, the plurality of subframes to a cluster of encoding servers, wherein the cluster of encoding servers is to encode the plurality of subframes in parallel, and wherein each subframe of the plurality of subframes is to be encoded by a particular encoding server of the cluster of encoding servers.

13. The storage medium of claim 12, wherein:
the frame comprises an encoded frame; and
the instructions that cause the machine to partition the frame into the plurality of subframes based on the number of subframes to be encoded in parallel further cause the machine to:
decode the encoded frame into a raw frame; and
partition the raw frame into the plurality of subframes.

14. The storage medium of claim 12, wherein the instructions that cause the machine to determine the number of subframes to be encoded in parallel for the frame further cause the machine to:
determine the number of subframes to be encoded in parallel based at least in part on:
a type of video content within the video stream; and
a compute requirement for encoding the type of video content within the video stream.

15. The storage medium of claim 12, wherein the instructions that cause the machine to send, via the communication interface, the plurality of subframes to the cluster of encoding servers further cause the machine to:
send, via the communication interface, frame metadata to the cluster of encoding servers, wherein the frame metadata is to indicate positions of the plurality of subframes within the frame.

16. The storage medium of claim 12, wherein the instructions further cause the machine to:
partition the frame into one or more subframes to be encoded locally; and
encode the one or more subframes in parallel with the plurality of subframes encoded by the cluster of encoding servers.

17. The storage medium of claim 12, wherein the cluster of encoding servers is to encode the plurality of subframes using a plurality of video codecs, wherein each subframe of the plurality of subframes is to be encoded using a particular video codec of the plurality of video codecs.

18. A method, comprising:
receiving, via a communication interface, a frame of a video stream;
determining a number of subframes to be encoded in parallel for the frame;
partitioning the frame into a plurality of subframes based on the number of subframes to be encoded in parallel; and
sending, via the communication interface, the plurality of subframes to a cluster of encoding servers, wherein the cluster of encoding servers is to encode the plurality of subframes in parallel, and wherein each subframe of the plurality of subframes is to be encoded by a particular encoding server of the cluster of encoding servers.

19. The method of claim 18, wherein:
the frame comprises an encoded frame; and
partitioning the frame into the plurality of subframes based on the number of subframes to be encoded in parallel comprises:
decoding the encoded frame into a raw frame; and
partitioning the raw frame into the plurality of subframes.

20. The method of claim 18, wherein determining the number of subframes to be encoded in parallel for the frame comprises:
determining the number of subframes to be encoded in parallel based at least in part on:
a type of video content within the video stream; and
a compute requirement for encoding the type of video content within the video stream.

21. The method of claim 18, further comprising:
partitioning the frame into one or more subframes to be encoded locally; and
encoding the one or more subframes in parallel with the plurality of subframes encoded by the cluster of encoding servers.

22. The method of claim 18, wherein the cluster of encoding servers is to encode the plurality of subframes using a plurality of video codecs, wherein each subframe of the plurality of subframes is to be encoded using a particular video codec of the plurality of video codecs.

23. A system, comprising:
a frame chunking server, wherein the frame chunking server comprises circuitry to:
receive, via a network, a frame of a video stream;
determine a number of subframes to be encoded in parallel for the frame;
partition the frame into a plurality of subframes based on the number of subframes to be encoded in parallel; and
send, via the network, the plurality of subframes to a cluster of encoding servers; and
the cluster of encoding servers, wherein the cluster of encoding servers comprises circuitry to:
receive, via the network, the plurality of subframes from the frame chunking server;
encode the plurality of subframes into a plurality of encoded subframes using one or more video codecs, wherein the plurality of subframes is to be encoded by the cluster of encoding servers in parallel, and wherein each subframe of the plurality of subframes is to be encoded by a particular encoding server of the cluster of encoding servers; and
send, via the network, the plurality of encoded subframes to a network destination corresponding to the video stream.

24. The system of claim 23, wherein each encoding server of the cluster of encoding servers comprises one or more hardware video encoders to encode one or more subframes of the plurality of subframes.

25. The system of claim 23, wherein the network destination comprises a storage server, wherein the storage server comprises a data storage device to store the plurality of encoded subframes.
